(19) United States
(12) Patent Application Publication
(10) Pub. No.: US 2006/0269726 A1
(43) Pub. Date: Nov. 30, 2006

(54) Graphic mat and method of producing the same

(76) Inventor: Art R. de St. Aubin, Canton, OH (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/139,966

(22) Filed: May 27, 2005

(51) Int. Cl. G03G 7/00

(52) U.S. Cl. 428/195.1

(57) ABSTRACT

The present invention is directed to a protective mat having a body portion with an upper and lower surface, and further having a graphic image printed on the lower surface of the body such that the image is visible through the upper surface of the mat. Another aspect of the present invention provides a backing to increase visibility of the graphic image when the protective mat is in use.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### BACKGROUND OF THE INVENTION

1. Field of the Invention

The present invention relates generally to a protective mat and, more specifically, to a protective mat having a decorative graphic associated therewith.

2. Description of Related Art

Protective mats are well-known in the art, and are commonly used in home and office settings as protective coverings for carpeting, hardwood floors, vinyl floors, furniture, or other surfaces. Such mats typically have a main body upon which a desk chair or other article is situated. The main body has a relatively hard, smooth surface upon which the chair is able to roll, and a forward lip portion that extends under a desk such that a person sitting in the chair can place his feet on the lip portion.

Known protective mats are generally constructed from a clear or translucent plastic material so that the floor or surface beneath the mat remains visible while the mat is in use. Despite the use of clear or translucent materials, however, the mat remains visible. It is desirable in certain situations to add a decorative element to the mat.

Known decorative protective mats include various layers such as, for example, a base portion that contacts the floor, a graphic portion having the desired decorative pattern, and an upper protective layer. These layers are generally secured to one another by use of adhesives. For example, an adhesive is used to secure the bottom of the graphic portion to the top of the base portion, and then an adhesive is further used to secure the bottom of the protective layer to the top of the graphic portion, thereby providing the complete mat.

The inclusion of various layers and adhesives can require additional steps during the production of the mat, such as, for example, manufacturing the various structural layers (base, graphic, protective layer, etc.) separately from one another. Further, such a structure provides increased opportunity for failure of the mat at specific points within the structure thereof. For example, if either of the adhesive layers fails, the mat will come apart.

What is needed, therefore, is a protective mat incorporating a graphic design, the mat having a single structural layer with the image printed directly thereon.

### BRIEF SUMMARY OF THE INVENTION

The present invention is directed to a protective mat having a body portion with an upper and lower surface, and further having a graphic image printed on the lower surface of the body such that the image is visible through the upper surface of the mat. The image preferably covers a substantial portion of the surface area of the mat, though depending on the desired aesthetic, the image may cover any percentage of the surface area of the mat, ranging from a relatively small image to one that covers the entire mat.

Another aspect of the present invention includes a lip portion of the mat extending outwardly from the body portion. The graphic image on the lower surface of the body portion may extend to cover at least a portion of the lower surface of the lip portion.

Another aspect of the present invention includes securing portions such as velcro ‘coins,’ patches, or strips, or adhesive patches or strips present on the lower surface of the protective mat.

Another aspect of the present invention includes the use of a non-skid application on the lower surface of the body and lip portions to increase the safety of the mat during use. A static dissipative material may also be applied to mat, or mixed with the polymer material or materials from which the mat is constructed, to prevent static build-up, thereby protecting sensitive equipment such as computers located in the vicinity of the mat.

In another aspect of the present invention, a backing, such as a layer of white ink, is printed on, or otherwise applied to, the lower surface of the mat after the printing of the graphic image thereon. This provides contrast so that the graphic image is visible when the mat is in use.

The present invention is also directed to a method of producing a mat as described above by printing a graphic image on the lower surface thereof. In one aspect of such a method, a screen printing device is used to print the graphic image on the lower surface of the mat (including the lip portion, if desired). In another aspect of the method, a backing layer, such as a layer of white ink, may be added to increase the visibility of the graphic image when the mat is in use.

### BRIEF DESCRIPTION OF THE DRAWINGS

FIG. 1 is a top perspective view of a protective mat constructed in accordance with the teachings of the present invention.

FIG. 2 is a schematic illustration of a typical screen printing device.

FIG. 3 is a top perspective view of a protective mat constructed in accordance with the teaching of the present invention further including a lip portion.

### DETAILED DESCRIPTION OF THE INVENTION

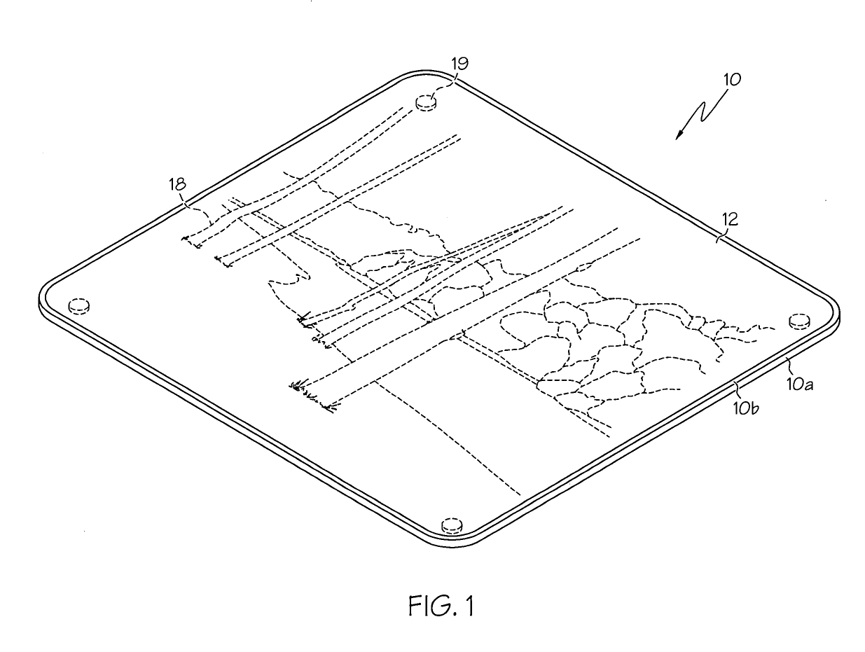

Turning now to the drawings, wherein like numerals indicate like parts, the numeral 10 refers generally to a protective mat constructed in accordance with the teachings of the present invention. FIG. 1 provides an illustration of a representative mat for use on a floor. The protective mat is presented in FIG. 1 such that a top or upper surface of the mat is facing ‘up’ and is visible in the figure. Protective mat 10 includes a body 12, which makes up the majority of the surface area of mat 10 and upon which a chair is able to move without damaging the floor beneath. Protective mat 10 also includes an upper surface 10b and an under surface 10a. Protective mat 10 further includes a graphic image 18 printed on under surface 10a thereof.

Protective mat 10 may further include at least one securing portion 19 in order to secure the protective mat to the surface upon which it rests. Any suitable method of securing protective mat 10 may be used, the nature of the surface upon which the mat rests being important in determining which methods of securing the mat are suitable. For example, If protective mat 10 is adapted for use on carpet, securing portions 19 may be small velcro ‘coins,’ patches, or strips that will interact with the carpeting in such a way as to provide stability to the mat. If protective mat 10 is adapted for use on a table, hardwood floor, linoleum floor, or similar surface, securing portions 19 may be adhesive patches or strips that will adhere to the protected surface, thereby holding the mat in place. It is contemplated that any suitable size, shape, and number of securing portions 19 may be used.

Though any suitable method may be used for producing graphic image 18 on under surface 10a of the present mat, such as, for example, rotogravure, ink jet printing, and others, one particularly suitable method is a “screen printing” method. Various suitable screen printing procedures exist and are well-known in the art, and any of them may be suitable for use with the present invention. One such method, however, will now be described.

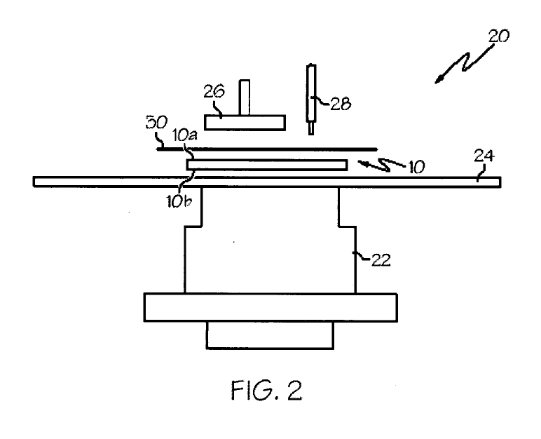

FIG. 2 provides a schematic illustration of a typical screen printing device with a protective mat 10 placed thereon, with under surface 10a facing up for printing. Under surface 10a of mat 10 is positioned on the machine in such an orientation to ensure that the bottom of the mat is positioned to receive ink thereon. Screen printing machine 20 is then used to apply ink to under surface 10a of the mat in the appropriate graphical design. Screen printing machine 20 includes a base portion 22 and a flat, table-like portion 24 upon which a substrate, in this case protective mat 10, is placed. A screen mask 30 is placed over the substrate. Screen mask 30 is a template for the graphical image to be applied to protective mat 10. Ink is dispensed onto screen mask 30 through dispenser 28, and squeegee head 26 forces the ink through the openings in screen mask 30 and onto protective mat 10 in such a manner as to produce the desired graphical image. Generally, one color will be applied to the mat and an appropriate time interval will be allowed to pass thereafter, allowing the color on the mat to dry completely before the next color is applied to the mat. The process of applying a color, waiting for the color to dry, then applying the next color, is repeated until the graphic image to be produced on the mat is completed.

Additional steps may be undertaken to impart additional qualities or features to the mat. For example, depending on the color, size, or other features of the graphic image produced on the underside of the mat, the graphic image may not be highly visible through the mat. If, for example, colors in the graphic image are close in hue to the colors of the surface on which the mat is placed, or if the surface is dark in color, the graphic image may blend into the protected surface such that it is hard to see. Therefore, an additional “printing” step may be undertaken in the production of the present mat. In this step, a white color is printed on the underside of the mat, providing a backing thereto. With such a backing in place, the graphic image on the mat will be seen with a great deal of clarity regardless of the surface upon which the mat is placed because the backing provides a contrast to the graphic image. Alternatively, a color other than white may be used for the backing.

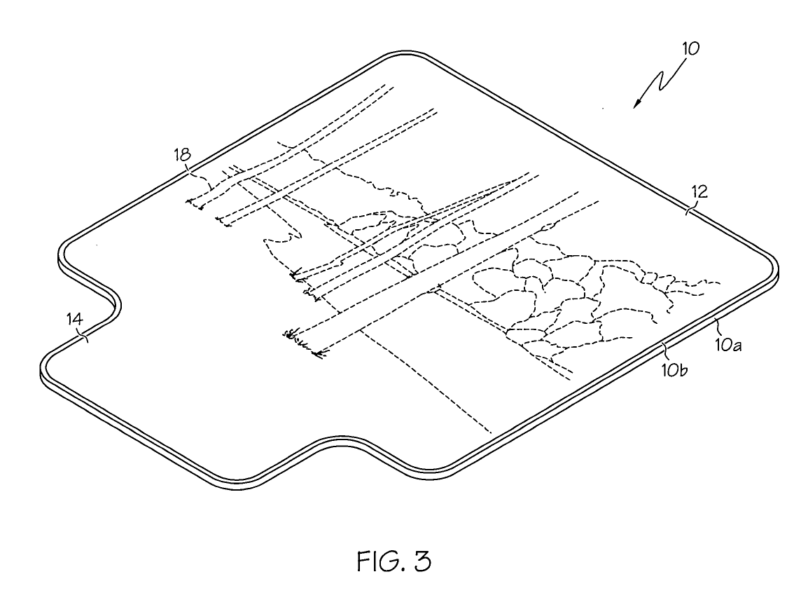

FIG. 3 provides a perspective view of an alternative embodiment of the protective mat of the present invention wherein the mat includes a lip portion 14 extending outward from body 12. Lip portion 14 may be an integral part of body 12, or may be otherwise attached thereto. Lip portion 14 is preferably sized, shaped, and positioned such that a person seated in a chair on protective mat 10 can place her feet on lip portion 14. In this embodiment of protective mat 10, upper surface 10b and under surface 10a extend across lip 14.

Another step that may be undertaken is the inclusion of a non-skid application on under surface 10a of the mat. Addition of a non-skid application creates a non-skid grid pattern that increases the safety of the mat while in use. Commonly used non-skid agents that may be applied to the surface of a mat include non-skid agents comprising aluminum oxide, polyurethane, acrylic, epoxies, various elastomers, and combinations thereof. Any suitable compound or agent used to raise the coefficient of friction between the mat and another object contacting the surface thereof may be used. In embodiments of the present invention having at least one securing portion 19 included thereon, the non-skid application is not applied to the areas where securing portions 19 are attached to the mat.

Protective mats produced in accordance with the teachings of the present invention may be constructed from various materials, such as vinyl, polyvinyl chloride, polypropylene, and the like. Any suitable material may be used without departing from the scope of the present invention. Mats designed for use on hardwood or vinyl surfaces may include a non-skid application on the lower surface of the mat, as described above, to prevent slippage of the mat across the hardwood or vinyl surface. Other suitable means of holding the mat in place on a variety of surfaces may be used.

Some mats may further include a static dissipative, such that static electricity is dissipated before it can accumulate to levels that may damage computer hardware or other sensitive items located in the vicinity of the mat. The use of such a static dissipative may be included on floor mats designed for carpeted floors, hardwood, vinyl, or other floors, or on protective mats designed for desktop or tabletop use.

A mat constructed in accordance with the teachings of the present invention may be provided in a variety of sizes and shapes according to the use for which a specific mat is designed. For example, a typical floor mat for use in an office setting may range in size from 36×48 inches to 72×96 inches, 60×120 inches, or more. Mats designed for use on table tops may range from placemat-sized mats, being from about 9×12 inches to about 12×16 inches or more, to larger mats that cover an entire table. Custom-sized mats can also be produced for various applications. The sizes stated herein are illustrative and are not meant to limit the present invention. Regardless of the size of mat produced, the graphic image associated therewith may cover the entire bottom surface of the mat or some lesser portion thereof.

The foregoing description of the embodiments of the invention has been presented for purposes of illustration and description, and is not intended to be exhaustive or to limit the invention to the precise form disclosed. For example, although the preferred embodiment discussed herein relates primarily to a protective floor mat, the present invention includes protection mats adapted for use with a variety of surfaces, including desks, furniture, and the life. The description was selected to best explain the principles of the invention and practical application of these principles in order to enable others skilled in the art to best utilize the invention in various embodiments and with such modifications as are suited to the particular use contemplated. It is intended that the scope of the invention not be limited by the specification, but be defined by the claims as set forth below.

1. A protective mat comprising a body portion, said body portion having an upper surface and a lower surface, wherein said lower surface of said body portion has a graphical image printed thereon.

2. A protective mat according to claim 1 further comprising a lip portion integral with said body portion and extending therefrom.

3. A protective mat according to claim 1 further comprising a backing layer printed on said lower surface of said mat such that said graphical image is between said backing layer and said lower surface of said mat.

4. A protective mat according to claim 1 further comprising a non-skid adhesive applied to a lower surface thereof.

5. A protective mat according to claim 1 further comprising at least one securing portion fixedly attached to the lower surface thereof, said securing portion providing at least some adherence to a surface upon which said protective mat is used.

6. A protective mat according to claim 2 further comprising a backing layer printed on said lower surface of said mat such that said graphical image is disposed between said backing layer and said lower surface of said mat.

7. A protective mat according to claim 2 further comprising a non-skid adhesive applied to a lower surface thereof.

8. A protective mat according to claim 2 further comprising at least one securing portion fixedly attached to the lower surface thereof, said securing portion providing at least some adherence to a surface upon which said protective mat is used.

9. A protective mat according to claim 5 further comprising a non-skid adhesive material applied to a lower surface thereof.

10. A protective mat according to claim 5 further comprising a static dissipative material applied thereto.

11. A protective mat according to claim 5 further comprising at least one securing portion fixedly attached to the lower surface thereof, said securing portion providing at least some adherence to a surface upon which said protective mat is used.

12. A protective mat comprising:
a body portion having an upper surface and a lower surface; and
a lip portion integral with said body portion and extending therefrom,
wherein said lower surface of said body portion has a graphical image printed thereon, and further wherein said lower surface of said body has a backing layer printed thereon such that the graphical image is disposed between the backing layer and the lower surface of said body portion.

13. A protective mat according to claim 12 wherein said lip portion includes an upper surface and a lower surface, and at least a portion of a graphical image is printed on said lower surface of said lip portion.

14. A protective mat according to claim 12 further comprising at least one securing portion fixedly attached to the lower surface thereof, said securing portion providing at least some adherence to a surface upon which said protective mat is used.

15. A method of producing a protective mat having a graphic image associated therewith comprising the steps of printing said graphic image on a lower surface of said mat and printing a backing layer over said graphic image such that said graphic image is disposed between said backing layer and said lower surface of said mat.

16. A method according to claim 15 wherein said graphic image is printed on said protective map using a screen printing method.

17. A method of producing a protective mat having a graphic image associated therewith comprising the steps of:
a) providing a protective mat;
b) applying a colored ink to a lower surface of said mat;
c) allowing said colored ink to dry;
d) applying a next colored ink to a lower surface of said mat;
e) allowing said next colored ink to dry; and
f) iteratively performing steps a) through d) until said graphic image is produced on said mat.

18. A method according to claim 17 further comprising the step of printing a backing layer over said graphic image such that said graphic image is disposed between said backing layer and said lower surface of said mat.

19. A method according to claim 18 further comprising the step of applying to a lower surface of said mat a non-skid material.

20. A method according to claim 18 further comprising the step of fixedly attaching at least one securing portion to a lower surface of said mat.
